(19) United States
(12) Patent Application Publication
(10) Pub. No.: US 2020/0007478 A1
(43) Pub. Date: Jan. 2, 2020

(54) INFORMATION PUSH CONTROL

(71) Applicant: Shanghai Bilibili Technology Co., Ltd., Shanghai (CN)

(72) Inventors: Yao JIANG, Shanghai (CN); Zuojian TIAN, Shanghai (CN)

(21) Appl. No.: 16/453,959

(22) Filed: Jun. 26, 2019

(30) Foreign Application Priority Data
Jun. 29, 2018 (CN) 201810715389.6

(51) Int. Cl. H04L 12/58; G06F 3/0484; G06F 3/0488

(52) U.S. Cl. CPC H04L 51/046; H04L 51/043; G06F 3/04886; G06F 3/04847

(57) ABSTRACT

Techniques for controlling information push within an application platform comprising a plurality of functional modules are described herein. The disclosed techniques include obtaining custom information associated with a group of users; determining a second content to be displayed in at least one second interface and a format of displaying the second content in the at least one second interface based at least in part on the custom information and at least one predetermined rule; generating the at least one second interface comprising the determined second content displayed in the determined format; determining a location of displaying the at least one second interface above a first interface associated with the first functional module based at least in part on a first content displayed in the first interface; and pushing the at least one second interface so as to display the at least one second interface above the first interface at the determined location.

### CROSS-REFERENCE TO RELATED APPLICATION

The present application claims priority of Chinese patent application No. 201810715389.6, filed on Jun. 29, 2018. The entire disclosure of the above-identified application is hereby incorporated by reference herein and made a part of this specification.

### BACKGROUND

Users may attempt to access conventional social media on their devices to communicate about interesting content. Using conventional social media may be cumbersome as users may have to switch back and forth between different applications. As communication devices, such as mobile phones, become more sophisticated, people continue to discover new ways to communicate.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a flowchart illustrating an example process of controlling information push in accordance with the present disclosure.

FIG. 2 is a schematic diagram illustrating an example non-interference area for displaying floating card information in accordance with the present disclosure.

FIG. 3 is a schematic diagram illustrating example floating card information displayed at the non-interference area in accordance with the present disclosure.

FIG. 4 is a schematic diagram illustrating an example implementation of the floating card information in accordance with the present disclosure.

FIG. 5 is a flowchart illustrating an example process of displaying the floating card information based on determining whether a user is a new user in accordance with the present disclosure.

FIG. 6 is a schematic diagram illustrating an example non-interference area changing from A to B in accordance with the present disclosure.

FIG. 7 is a schematic block diagram illustrating an example device of controlling information push in accordance with the present disclosure.

FIG. 8 is a schematic diagram illustrating an example computing device that may be used in accordance with the present disclosure.

### DETAILED DESCRIPTION OF ILLUSTRATIVE EMBODIMENTS

Hereinafter the disclosure will be further illustrated in details by combining the accompanying drawings and the embodiments. It can be understood that the specific embodiments described here are used only to explain the disclosure, and do not limit the disclosure. It should also be noted that, in order to describe conveniently, only parts of the structure related to the disclosure, not the whole structure, are shown in the accompanying drawings.

Before discussing the exemplary embodiments in more details, it should be mentioned that, some exemplary embodiments are described as processes or methods depicted as flowcharts. Although the steps in the flowcharts are described to be performed sequentially, many of them can be implemented in parallel, concurrently or simultaneously. In addition, the sequences of the steps can be rearranged, and the process can be terminated when its operation is completed, but it can contain other steps not included in the accompanying drawings. The processes can correspond to methods, functions, procedures, subroutines, subprograms, etc.

The disclosure relates to a group information pushing control method, a group information pushing control device and a computer-readable storage medium, which are mainly used in the scenario of displaying related information of other function modules in the chat window of the group in some integrated application platforms. The basic idea is that: in an integrated application platform, each function module is responsible for its unique function, for example the live broadcasting module is responsible for the live broadcasting function, the news module is responsible for the news function, the group chat module is responsible for the group user chat function, etc. When the user needs to pay attention to the related information (information customized according to the group's needs) of other function modules in real time in the group chat process, he can receive and view the related information just in the chat window, and the related information received is displayed by floating over the interface of the chat window in the form of floating card information, and the display parameters of the floating card information can also be set by the user himself The information pushing control solution enables the user in the group to view rich information without exiting the current chat window of the group.

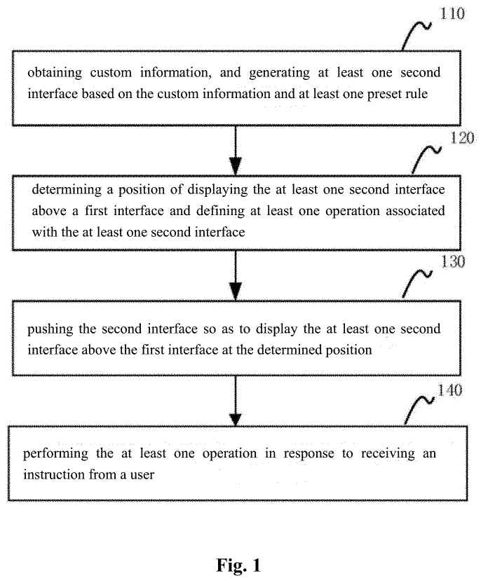

The embodiments can be applied to the application platform with information control module for group information pushing control. The method can be implemented by an information control device, wherein the device can be implemented by software and/or hardware, and can be generally integrated into the application platform or the chat function module, as shown in FIG. 1, it is a flowchart of a group information pushing control method of the disclosure, and the method specifically comprises the following steps:

In the step 110, custom information of a group is obtained, and generating at least one second interface (e.g., a floating card window) based on the custom information and at least one preset rule, wherein the custom information is the information generated by other function modules different from the group in the application platform to which the group belongs;

In the exemplary embodiment of the disclosure, the group belongs to the user group under the application platform, and the chat module of the group belongs to a function module under the application platform. Generally, the application platform includes two or more different function modules.

In a feasible implementation of the exemplary embodiment, the application platform can be a live broadcasting platform, the group is a fan group of the anchor user in the live broadcasting platform, other function modules different from the group are picture function module, video function module and news specific column module, etc., the anchor user or authorized live broadcasting audiences can post pictures through the picture function module, post videos through the video function module, find information such as news and so on related to the identity information through the news function module, the custom information of the group is the information generated from the picture function module, the video function module, the news specific column module, etc.

Obtaining the custom information of the group can be obtaining the custom information meeting the requirement from other function modules such as the video function module, the news specific column module and so on, when the group is a fan group of an anchor user, the custom information can be picture information, video information posted by the anchor user, and news information, specific column information, etc. related to the anchor user.

The custom information can also be other types of information, and the information meeting the customization condition of the group is the custom information, the customization condition can be formulated according to the majority of the group users in the group, by the establisher of the group, or by the anchor user that the group belongs to, and it is not limited to the custom information listed above.

In different systems, the processes of generating at least one second interface based on the custom information and at least one preset rule may be different. By way of example and without any limitation, in the Android operating system, it is necessary to define the FrameLayout (frame floating) layout layer at the bottom of the Android so that the at least one second interface is displayed above the display layer of the chat window of the group (i.e., the first interface).

The at least preset rule can be a conversion rule for converting the custom information into the floating card information included in the at least one second interface, such as the display mode, the display frame format, the display content, whether to display pictures or not, etc. after the conversion. In a more specific implementation, the display mode of the floating card information can be determined according to the content form parameter and the content quantity parameter of the custom information, the floating card information is generated in the display mode determined according to the preset rule, for example, when the floating card information is a picture, its content form parameter is a picture format including .jpg and .png, etc., at this time, according to the size of the picture, whether the floating card information is displayed partially or not, whether the floating card information is displayed abbreviatedly or not, etc. are determined according to the preset rule.

When the content form parameter is the text format including .txt, the content can be displayed by combining the content amount, that is to say, how many characters are included. Similarly, whether the characters are displayed partially or not, whether the content amount of the characters is displayed or not, etc. are determined according to the preset rule.

In the step 120, a position of displaying the at least one second interface above the first interface is determined and at least one operation associated with the at least one second interface is defined;

In an exemplary embodiment of the disclosure, when the application platform is in the Android operating system, the floating display position and the operation command of the floating card information can be defined through the floating layer manager.

In the step 130, the at least one second interface is pushed and displayed by floating on the top of the first interface at the determined display position;

After the display position and the operation command are determined, the generated at least second interface (e.g., floating card) including the custom information can be displayed according to the definition, that is to say, the floating card information is displayed at the determined display position, and specific operations are performed to the at least one second interface according to the operation command defined.

In the step 140, specific operations to the at least one second interface are performed in response to receiving instructions from users.

After the operation command is received, according to the operation content of the operation command, for example, “left-right sliding operation→closing the floating layer” and “up-down sliding operation→switching the floating layer” are defined at the time of definition, then the floating card information is closed when the left-right sliding operation to the floating card information is obtained, and the current display of the floating card information is switched when the up-down sliding operation to the floating card information is obtained. The operation content of the operation command can also have other operation forms, which are not listed here.

The method of the disclosure converts the custom information into the floating card information at the background and displays it by floating it above the interface of the chat window of the group when the custom information generated by other function modules in the same application platform and meeting the customization requirement of the group is obtained in the group chat process, the floating display position, the sliding direction, the closing mode, etc. of the floating card information can be defined according to the requirements, making the interface of the chat window of the group display the information of other function modules different from the group function module, and the floating display position of the floating card information can be changed according to the requirements, the floating card information is closed, slide, switched through the operation command, for users, the display mode is novel and the corresponding information can be obtained in time, for the application platform, it can provide chat topics to the group users to increase the stickiness of the group chat users.

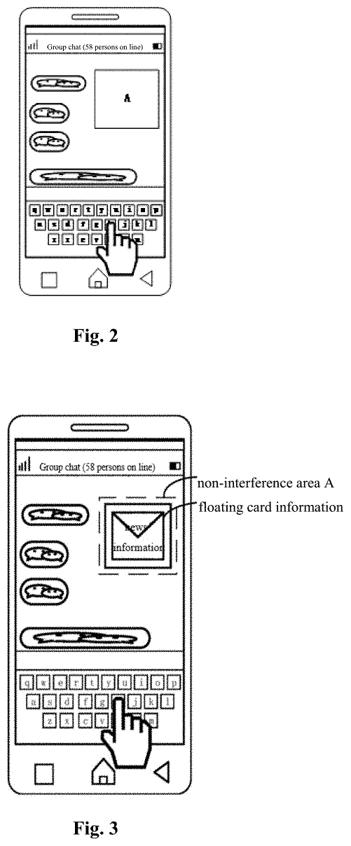

In another feasible implementation scenario of an exemplary embodiment of the disclosure, the step of defining the floating display position of the floating card information comprises the step that the floating display position of the floating card information defined does not interfere with the position of the information generated by the chatting of the users, so as to minimize the interference to the chat process of the group chat users, as shown in FIG. 2, it is a schematic diagram of the floating display position of the floating card information according to an exemplary embodiment of the disclosure. Of course, it is not limited to the mobile terminals shown in FIG. 2 to FIG. 4 only, and can also be other various forms of terminals and various kinds of operating systems, firstly, a non-interference area that does not interfere with the display of the group chat messages is determined according to the display mode of the group chat messages of the group; during the group chat process, chat information is sent from one side, due to the length of the information, the relative side of the side sending the information shows less chat information, at this time, the relative side of the side sending the information can be determined as the non-interference area. As shown in FIG. 2, the icon information in the figure represents the group chat information generated in the group chat process. At this time, the non-interference area can be determined as the area A according to the above mentioned determination method.

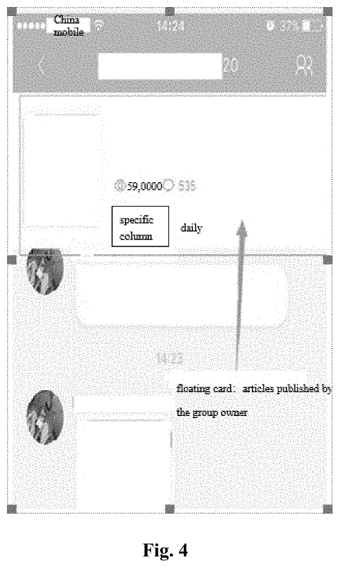

Then, the non-interference area is taken as the display position, and the floating card information is floating in the non-interference area. After the area A is determined as the non-interference area, by combining FIG. 3, the floating card information can be displayed by floating at any of the suitable positions in the area A.

In a specific implementation of an exemplary embodiment of the disclosure, as shown in FIG. 4, it is a schematic diagram that an exemplary embodiment of the disclosure displays the floating card information in an application platform, the floating card information is displayed by floating at the upper part of the chat window (the upper part relative to the sending position of the chat information), the customization condition of the floating card information is the articles published by the group owner.

By determining the non-interference area of the chat window as the floating display position of the floating card information, the method of the disclosure minimizes the occurrence of the situation that the block of the floating card information to the chat information affects the viewing of the group chat user to the chat information.

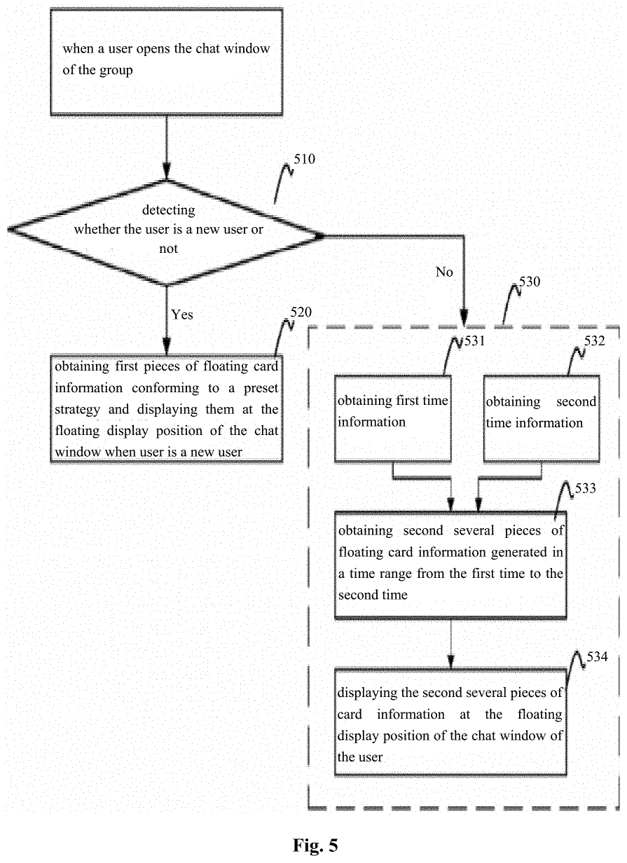

In a feasible implementation scenario of an exemplary embodiment of the disclosure, the method further comprises determining whether a group chat user is a new user or not so as to determine the specific content and the specific quantity of the floating card information displayed after the user joins the group chat, as shown in FIG. 5, the process may comprises the following steps:

In the step 510, whether a group user is a new user or not is detected when the group user opens the chat window of the group;

It detects whether the group user entering newly by clicking is a new user or not in the background, and when it detects the operation that the user opens the chat window of the group, it enters into the step of detecting whether the user is a new user or not.

In the step 520, first several pieces of floating card information conforming to a preset strategy is obtained, and the first several pieces of floating card information is displayed by floating at the floating display position of the chat window of the group, when the group user is a new user;

For the group chat, the standard for judging whether a group chat user is a new user or not can be ways such as the time that the new user joins the group chat (for example, the new user whose time for joining the group chat is less than 1 minute is a new user) or whether the user name of the user joined newly is saved in the user list of the group chat, etc.

For a new user, the corresponding floating card information is displayed according to a preset strategy, which can be, displaying the floating card information with the “important event” label happened currently to the new user, then at this time, the corresponding floating card information is displayed to the new user.

In the step 530, when the group user is not a new user, the following steps are comprised:

In the step 531, first time information when the group user joined the group chat last time is obtained;

In the step 532, second time information when the group user joins the group chat currently is obtained;

In the step 533, second several pieces of floating card information in the time range between the first time information and the second time information is obtained;

In the step 534, the second several pieces of floating card information is displayed by floating at the floating display position of the chat window of the group user.

In a specific implementation scenario of an exemplary embodiment of the disclosure, when the user joining the group chat is an old user M (not a new user), the first time information when the old user M joined the group chat last time, such as “2018:.06.01, 05:58”, is obtained, the second time information when the old user M joins the group chat currently (this time) is “2018:.06.10, 12:58”, then at this time, for the old user M, because the old user is a user who often logs in to join the group chat, the floating card information before the first time information has been displayed to him, at this time, the information displayed is ignored, and the floating card information converted from the custom information occurred when the old user M did not log in and meeting the customization condition is preferentially selected to display.

The method of the disclosure shows different floating card information according to different strategies when new and old users join the group chat, and the differentiated display mode can better enhance the user experience of the group chat users.

In a feasible implementation scenario of an exemplary embodiment of the disclosure, the method further includes updating the display of the floating card information generated newly at the floating display position of the chat window of the group when the floating card information generated newly is obtained during the chat process of the group.

In a feasible implementation of an exemplary embodiment of the disclosure, for example, when a group chat is going on, when the news “the title of the news is “fugitive buster”” of a core person of the group chat, such as Zhang Mouyou, is published at other application platforms or other application modules, by combining FIG. 4, at this time, the news is obtained in time and converted into the latest floating card information, and the latest floating card information is displayed in the chat window of the group according to the preset rule.

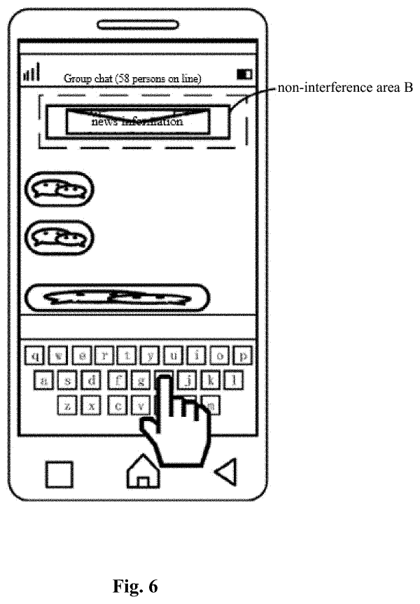

In a feasible implementation scenario of an exemplary embodiment of the disclosure, the method further includes changing the change position of the floating card information when the floating display position changes during the chat process of the group, specially, changing the display mode of the floating card information correspondingly according to the change of the floating display position when the floating display position changes, by combining FIG. 3 and FIG. 6, for example, when the non-interference area changes from A to B according to the preset rule, at this time, the display of the floating card information is changed according to the change of the non-interference area.

In a more specific implementation of an exemplary embodiment of the disclosure, the step of performing specific operations to the floating card information according to the operation content of the operation command received, comprises at least the following several specific operations:
receiving a hiding and/or transparentizing instruction to the floating card information from a user, and performing the hiding and/or transparentizing processing to the floating card information;

The hiding instruction can hide the floating card information at the edge of the chat window, and the transparentizing instruction can set the floating card information to be transparent (the transparency can be set).
receiving a reducing and/or enlarging instruction to the floating card information from the user, and performing the reducing and/or enlarging processing to the floating card information;

The enlarging instruction can enlarge the floating card information, while the reducing instruction can reduce the floating card information, similarly, the reducing and/or enlarging instruction can be applied to not only the whole floating card information, but also the specific content of the floating card information, such as enlarging or reducing the text information in the floating card information.
receiving a touch instruction to the floating card information from the user, and performing a sliding and/or opening processing to the floating card information.

For example, clicking on the floating card information can open the corresponding links about news, pictures, videos, etc., and can also be switched to specific web page links, when the switching operation is performed, one piece of the floating card information can be switched to another piece of the floating card information.

The method of the disclosure enables each specific operation content correspond to specific operations to the floating card information by limiting the specific operation content, which provides great convenience for the group users to view and switch the floating card information.

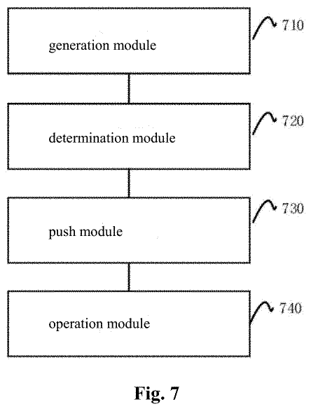

FIG. 7 is a schematic diagram of the structure of a group information pushing control device provided by an embodiment of the disclosure, the device can be implemented by software and/or hardware, is generally integrated into an application platform, and can be implemented by a group information pushing control method. As shown in the figure, the present embodiment can provide a group information pushing control device based on the above mentioned embodiments, which mainly comprises a generation module 710, a determination module 720, a push module 730 and an operation module 740.

Wherein the generation module 710 is used to obtain custom information of a group, and convert the custom information into floating card information according to a preset rule, wherein the custom information is the information generated by other function modules different from the group in the application platform to which the group belongs;

Wherein the definition module 720 is used to determine the floating display position and the operation command of the floating card information;

Wherein the display module 730 is used to push and display the card information by floating at the determined display position;

Wherein the processing module 740 is used to perform specific operations to the floating card information according to the operation content of the operation command received.

In a feasible implementation scenario of an exemplary embodiment of the disclosure, the definition module comprises:
a determination submodule, used to determine a non-interference area that does not interfere with the display of the group chat messages according to the display mode of the group chat messages of the group;
a position determination submodule, used to take the non-interference area as the floating display position, and display the floating card information by floating in the non-interference area.

In a feasible implementation scenario of an exemplary embodiment of the disclosure, the conversion module 710 is further used for
determining the display mode of the floating card information according to the content form parameter and the content quantity parameter of the custom information;
generating the floating card information in the display mode determined according to the preset rule.

In a feasible implementation scenario of an exemplary embodiment of the disclosure, the device further comprises:
a detection module, used to detect whether a group user is a new user or not when the group user opens the chat window of the group;
a first display module, used to obtain first several pieces of floating card information conforming to a preset strategy, and displaying the first several pieces of floating card information floating at the floating display position of the chat window of the group, when the group user is a new user;
a second display module, used to comprise the following submodules when the group user is not a new user:
a first obtaining submodule, used to obtain first time information when the group user joined the group chat last time;
a second obtaining submodule, used to obtain second time information when the group user joins the group chat currently;
a subtraction submodule, used to obtain second several pieces of floating card information in the time range between the first time information and the second time information;
a second display sub-module, used to display the second several pieces of floating card information floating at the floating display position of the chat window of the group user.

In a feasible implementation scenario of an exemplary embodiment of the disclosure, the device further comprises:
an update module, used to update the display of the floating card information generated newly at the floating display position of the chat window of the group when the floating card information generated newly is obtained during the chat process of the group.

In a feasible implementation scenario of an exemplary embodiment of the disclosure, the device further comprises:
a change module, used to change the display mode of the floating card information correspondingly according to the change of the floating display position when the floating display position changes during the chat process of the group.

The modules provided in any one of the above mentioned embodiments can communicate with each other, and each module can communicate with the central control device of the platform. The group information pushing control device provided in any one of the above mentioned embodiments can execute the group information pushing control method provided in any embodiment of the disclosure, has corresponding function modules executing the method and corresponding beneficial effects produced by executing the method. For the technical details that are not described in details in the above mentioned embodiments, please refer to the group information pushing control method provided in any embodiment of the disclosure.

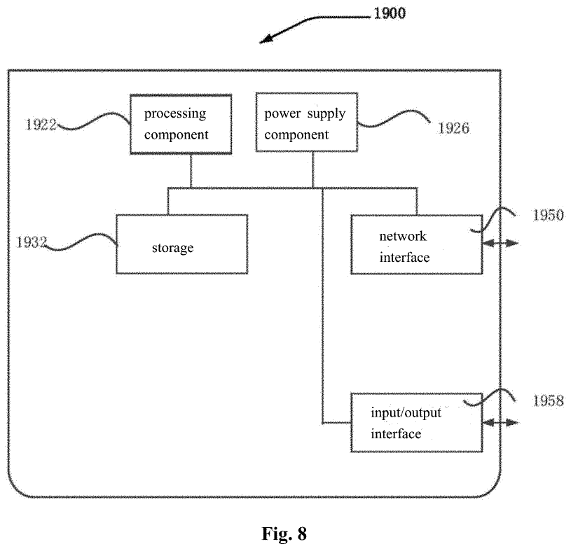

FIG. 8 is a block diagram of a computer device 1900 according to an exemplary embodiment. For example, the device 1900 can be provided as a server. Please refer to FIG. 8, the device 1900 comprises a processing component 1922, which further includes one or more processors and memory resources represented by the storage 1932 used to store instructions that can be executed by the processing component 1922, such as applications. The applications stored in the storage 1932 may include one or more modules each of which corresponds to a set of instructions. In addition, the processing component 1922 is configured to execute instructions, so as to execute the group information pushing control method of any one of the above mentioned embodiments.

The storage 1932 can be implemented by any type of volatile or non-volatile storage devices or their combinations, such as static random access memory (SRAM), electrically erasable programmable read-only memory (EEPROM), erasable programmable read-only memory (EPROM), programmable read-only memory (PROM), read-only memory (ROM), magnetic memory, flash memory. Disk or CD.

The device 1900 may further include a power supply component 1926 configured to perform power management of the device 1900, a wired or wireless network interface 1950 configured to connect the device 1900 to a network, and an input/output (I/O) interface 1958. The device 1900 can run operating systems stored in the storage 1932, such as WindowsServer™, MacOSX™, Unix™, Linux™, FreeBSD™ or the like.

In another implementation scenario of an exemplary embodiment of the disclosure, the present embodiment further provides a non-temporary computer-readable storage medium including instructions, such as flash memory, hard disk, multimedia card, card type memory (e.g., SD or DX memory, etc.), random access memory (RAM), static random access memory (SRAM), read-only memory (ROM), electrically erasable programmable read-only memory (EEPROM), programmable read-only memory (PROM), Magnetic Memory, Disk, CD, server, App application mall and so on, on which a computer program is stored, corresponding functions can be achieved when the program is executed by a processor, such as the storage 1932 including instructions. The non-temporary computer-readable storage medium of the present embodiment is used to store a financial applet, and the group information pushing control method of any one of the above-mentioned embodiments is implemented when it is executed by a processor.

Another embodiment involving a computer program product includes computer executable instructions corresponding to each of at least one device in the systems and/or the products illustrated. These instructions can be subdivided into subroutines and/or stored in one or more potentially statically or dynamically linked files.

The carrier of the computer program may be any entity or device capable of carrying the program. For example, the carrier may contain a storage medium, for example ROM (such as CDROM or semiconductor ROM) or magnetic recording medium (such as floppy disk or hard disk). Furthermore, the carrier may be a transferable carrier, such as an electrical or optical signal, which may be transmitted via a cable or an optical cable, or by radio or other means. When the program is specified as such a signal, the carrier can be composed of such a cable or device. Alternatively, the carrier may be an integrated circuit in which a program is embedded, and the integrated circuit is suitable for executing the related method or used by the execution of the related method.

It should be noted that, the embodiments mentioned above are illustration of the disclosure, rather than limiting the disclosure, and the technicians skilled in the art will be able to design many alternative embodiments without deviating from the scope of the appended claims. In the claims, any reference symbol placed between parentheses should not be construed as a limitation to the claims. The use of the verb “comprise” and its inflection does not exclude the existence of elements or steps other than those stated in the claims. The article “one” before the element does not exclude the existence of plural elements. The disclosure can be realized by hardware comprising several distinct components and properly programmed computers. Among the device claims enumerating several devices, some of these devices can be embodied by the same hardware. The mere fact that certain measures are stated in different depended claims does not mean that the combinations of these measures cannot be used to obtain benefits.

If desirable, the different functions discussed here can be performed in different orders and/or simultaneously with each other. In addition, if desirable, one or more of the functions described above may be optional or may be combined.

If desirable, the steps discussed above are not limited to the orders executed in the embodiments, and different steps may be executed in different orders and/or simultaneously with each other. In addition, in other embodiments, one or more of the steps described above may be optional or may be combined.

Although various aspects of the disclosure are given in the independent claims, other aspects of the disclosure include the combinations of the features from the embodiments described and/or the depended claims with the features of the independent claims, and are not just the combinations given explicitly in the claims.

It should be noted here that, although the exemplary embodiments of the disclosure have been described above, these descriptions should not be understood as the meaning of limitations. On the contrary, a number of changes and modifications may be made without departing from the scope of the disclosure as defined in the appended claims.

It should be understood by the technicians skilled in the art that, the modules in each of the devices of the embodiments of the disclosure can be implemented by at least one general computing device, the modules can be integrated in a single computing device or a network group composed of computing devices. The devices in the embodiments of the disclosure correspond to the methods in the embodiments described above, which can be implemented by executable program codes or by the combination of executable program codes and integrated circuits, therefore the disclosure is not limited to specific hardware or software or their combinations.

It should be understood by the technicians skilled in the art that, the modules in each of the devices of the embodiments of the disclosure can be implemented by at least one general mobile terminal, the modules can be integrated in a single mobile terminal or a network group composed of mobile terminals. The devices in the embodiments of the disclosure correspond to the methods in the embodiments described above, which can be implemented by executable program codes or by the combination of executable program codes and integrated circuits, therefore the disclosure is not limited to specific hardware or software or their combinations.

Please note that the above contents are only the exemplary embodiments of the disclosure and the technical principles adopted by the disclosure. It will be understood by the technicians skilled in the art that the disclosure is not limited to the specific embodiments described herein, and various obvious changes, readjustments and substitutions can be made for the technicians skilled in the art without departing from the scope of protection of the disclosure. Therefore, although the disclosure has been described in more details through the above embodiments, it is not limited to the above embodiments, and can further include more other equivalent embodiments without departing from the concept of the disclosure, and the scope of the disclosure is determined by the scope of the appended claims.

What is claimed is:

1. A method of controlling information push within an application platform comprising a plurality of functional modules, comprising:
obtaining custom information associated with a group of users, wherein the custom information is generated by other functional modules that are different from a first functional module used by the group of users, and wherein the other functional modules and the first functional module are among the plurality of functional modules of the application platform;
determining a second content to be displayed in at least one second interface and a format of displaying the second content in the at least one second interface based at least in part on the custom information and at least one predetermined rule;
generating the at least one second interface, the at least one second interface comprising the determined second content displayed in the determined format;
defining at least one operation associated with the at least one second interface;
determining a location of displaying the at least one second interface above a first interface associated with the first functional module based at least in part on a first content displayed in the first interface;
pushing the at least one second interface so as to display the at least one second interface above the first interface at the determined location; and
performing the at least one operation in response to receiving an instruction from a user among the group of users.

2. The method of claim 1, further comprising:
determining a display mode of the at least one second interface based on a content form parameter and a content quantity parameter of the custom information.

3. The method of claim 2, further comprising:
changing the display mode of the at least one second interface in response to a change of the determined location.

4. The method of claim 1, wherein the first functional module is a chat module, the determined location is in an area where no chat message is displayed, and the at least one second interface floats above the first interface at the determined location.

5. The method of claim 1, wherein the at least one second interface comprises a plurality of second interfaces.

6. The method of claim 5, further comprising:
in response to receiving a request of opening the first interface from a user, determining whether the user is a new user.

7. The method of claim 6, further comprising:
pushing a first type of second interface among the plurality of second interfaces to the user in response to a determination that the user is a new user, wherein the first type of second interface is determined based on a predetermined rule.

8. The method of claim 6, further comprising:
in response to a determination that the user is not a new user, obtaining first timing information indicative of a first time when the user opened the first interface last time and obtaining second timing information indicative of a second time when the user opens the first interface this time; and
pushing a second type of second interfaces among the plurality of second interfaces to the user, wherein the second type of second interfaces were generated during a period from the first time to the second time.

9. The method of claim 1, further comprising:
updating the at least one second interface displayed above the first interface at the determined location when a new second interface is generated.

10. The method of claim 1, wherein the at least one operation comprises at least one of hiding, transparentizing, reducing, enlarging, sliding, or opening the at least one second interface.

11. A system of controlling information push within an application platform comprising a plurality of functional modules, comprising:
at least one processor; and
at least one memory communicatively coupled to the at least one processor and storing instructions that upon execution by the at least one processor cause the system to:
obtain custom information associated with a group of users, wherein the custom information is generated by other functional modules that are different from a first functional module used by the group of users, and wherein the other functional modules and the first functional module are among the plurality of functional modules of the application platform;
determine a second content to be displayed in at least one second interface and a format of displaying the second content in the at least one second interface based at least in part on the custom information and at least one predetermined rule;
generate the at least one second interface, the at least one second interface comprising the determined second content displayed in the determined format;
define at least one operation associated with the at least one second interface;
determine a location of displaying the at least one second interface above a first interface associated with the first functional module based at least in part on a first content displayed in the first interface;
push the at least one second interface so as to display the at least one second interface above the first interface at the determined location; and
perform the at least one operation in response to receiving an instruction from a user among the group of users.

12. The system of claim 11, wherein the first functional module is a chat module, the determined location is in an area where no chat message is displayed, and the at least one second interface floats above the first interface at the determined location.

13. The system of claim 11, the at least one memory further storing instructions that upon execution by the at least one processor cause the system to:
push a first type of second interface among a plurality of second interfaces to a first user in response to a determination that the first user is a new user, wherein the at least one second interface comprises the plurality of second interfaces, and wherein the first type of second interface is determined based on a predetermined rule.

14. The system of claim 11, the at least one memory further storing instructions that upon execution by the at least one processor cause the system to:
in response to a determination that a second user is not a new user, obtain first timing information indicative of a first time when the second user opened the first interface last time and obtaining second timing information indicative of a second time when the second user opens the first interface this time; and
push a second type of second interface among a plurality of second interfaces to the second user, wherein the at least one second interface comprises the plurality of second interfaces, and wherein the second type of second interface was generated during a period from the first time to the second time.

15. The system of claim 11, the at least one memory further storing instructions that upon execution by the at least one processor cause the system to:
update the at least one second interface displayed above the first interface at the determined location when a new second interface is generated.

16. The system of claim 11, wherein the at least one operation comprises at least one of hiding, transparentizing, reducing, enlarging, sliding, or opening the at least one second interface.

17. A non-transitory computer-readable storage medium comprising computer-readable instructions that upon execution on a computing device cause the computing device at least to:
obtain custom information associated with a group of users, wherein the custom information is generated by other functional modules that are different from a first functional module used by the group of users, and wherein the other functional modules and the first functional module are among the plurality of functional modules of the application platform;
determine a second content to be displayed in at least one second interface and a format of displaying the second content in the at least one second interface based at least in part on the custom information and at least one predetermined rule;
generate the at least one second interface, the at least one second interface comprising the determined second content displayed in the determined format;
define at least one operation associated with the at least one second interface;
determine a location of displaying the at least one second interface above a first interface associated with the first functional module based at least in part on a first content displayed in the first interface;
push the at least one second interface so as to display the at least one second interface above the first interface at the determined location; and
perform the at least one operation in response to receiving an instruction from a user among the group of users.

18. The non-transitory computer-readable storage medium of claim 17, further comprising computer-readable instructions that upon execution on the computing device cause the computing device at least to:
push a first type of second interface among a plurality of second interfaces to a first user in response to a determination that the first user is a new user, wherein the at least one second interface comprises the plurality of second interfaces, and wherein the first type of second interface is determined based on a predetermined rule.

19. The non-transitory computer-readable storage medium of claim 17, further comprising computer-readable instructions that upon execution on the computing device cause the computing device at least to:
in response to a determination that a second user is not a new user, obtain first timing information indicative of a first time when the second user opened the first interface last time and obtaining second timing information indicative of a second time when the second user opens the first interface this time; and
push a second type of second interface among a plurality of second interfaces to the second user, wherein the at least one second interface comprises the plurality of second interfaces, and wherein the second type of second interface was generated during a period from the first time to the second time.

20. The non-transitory computer-readable storage medium of claim 17, further comprising computer-readable instructions that upon execution on the computing device cause the computing device at least to:
update the at least one second interface displayed above the first interface at the determined location when a new second interface is generated.
